(19) United States
(12) Patent Application Publication
(10) Pub. No.: US 2025/0028932 A1
(43) Pub. Date: Jan. 23, 2025

(54) ARTIFICIAL INTELLIGENCE-BASED THREAT PREDICTION SYSTEM AND METHOD FOR CBRN

(71) Applicant: AGENCY FOR DEFENSE DEVELOPMENT, Daejeon (KR)

(72) Inventors: Hyunwoo NAM, Daejeon (KR); Minjae KANG, Daejeon (KR); Jungjae SON, Daejeon (KR); Byungheon LEE, Daejeon (KR)

(21) Appl. No.: 18/503,956

(22) Filed: Nov. 7, 2023

(30) Foreign Application Priority Data
Jul. 20, 2023 (KR) 10-2023-0094373

(51) Int. Cl. G06N 3/0442; G01T 1/167

(52) U.S. Cl. CPC G06N 3/0442; G01T 1/167

(57) ABSTRACT

An object of the present invention is to provide a system and a method for predicting Chemical, Biological, Radiological and Nuclear (CBRN) threatsj, which are more realistic and reliable by correcting actual sensor data measured in a given zone when a CBRN situation occurs or pollution diffusion and transfer and diffusion data for each time zone acquired by using a pollution diffusion prediction tool.

### CROSS-REFERENCE TO RELATED APPLICATION

This application claims priority to Korean Patent Application No. 10-2023-0094373 filed on Jul. 20, 2023, and all the benefits accruing therefrom under 35 U.S.C. § 119, the contents of which is incorporated by reference in its entirety.

### BACKGROUND OF THE INVENTION

### 1. Field of the Invention

The present invention relates to a system and a method for predicting a thread for chemical, biological, radiological and nuclear (CBRN), and more particularly, to a system and a method for predicting and correcting transfer and diffusion of chemical, biological, radiological and nuclear pollutants within a given restriction zone by utilizing artificial intelligence based U-Net technology with respect to CBRN data measured in a zone designated to a user or pollution concentration data in a region where measurement or prediction is restricted in a pollution prediction result calculated by pollution diffusion prediction modeling technology.

### 2. Description of the Related Art

Toxic chemical agents (CWA) used for the purpose of terrorist attacks such as neuropathy and blister agents, and toxic industrial chemicals (TIC) in an industrial complex are colorless and odorless, and in the case of leakage accidents, the leakage accidents can cause massive casualties in a short time.

In order to prevent damage to this in advance and monitor the spread of pollution, it is necessary to install and operate sensors in a protected region. However, since cost required for purchase and operation of a sensor device is quite large, CBRN proliferation modeling software technology has been utilized, which operates a detection sensor in the corresponding zone or predicts the transfer and spread of the CBRN pollutants.

As an example, as a Chemical, Biological, Radiological and Nuclear (CBRN) pollution-proliferation prediction tool), there a Nuclear, Biological, and Chemical Reporting And Modeling S/W System (hereinafter, NBC_RAMS) developed by the Defense Research Institute, and there is a HAZARD prediction and assessment capability (HPAC) system which is a hazard substance proliferation and influence prediction model in the atmosphere developed by the US Defense Threat Reduction Agency (DTRA).

The technology that predicts the proliferation of the CBRN pollution source in the related art conducts air current analysis by utilizing various weather models with given CBRN accidents, weather, geography, and building information as conditions, and a system is configured to calculate a prediction value for each time zone by utilizing a specific diffusion modeling technique with respect to a process of transferring and diffusing target pollutants into a calculation area.

However, in the case of such real detection sensor operations in the related art, wide area monitoring in a large area is somewhat limited due to reasons such as spatial installation restrictions and maintenance costs.

In addition, utilization of the CBRN pollutant diffusion prediction technology is somewhat limited to credibility demonstration of the prediction modeling technology, and there is a disadvantage in that there is a limit to predict the accurate pollution spread in various and complex shapes buildings in complex urban areas.

In such a situation, the need for a system and a method comes to the fore, which can reasonably complement and correct the development of a CBRN dangerous situation with higher fidelity based on given real detection sensor measurement data or pollution spread prediction result data.

### SUMMARY OF THE INVENTION

In order to solve the problem in the related art, an object of the present invention is to provide a system and a method for predicting a threat for CBRN, which are more realistic and reliable by correcting actual sensor data measured in a given zone when a CBRN situation occurs or pollution diffusion and transfer and diffusion data for each time zone acquired by using a pollution diffusion prediction tool.

Further, in order to solve the problem in the related art, an object of the present invention is to provide a system and a method for predicting a high-fidelity CBRN pollution diffusion degree based on U-Net technology which is an artificial intelligence technique in a background of various spaces defined by a user.

In order to achieve the object, the artificial intelligence based CBRN threat prediction system according to the present invention includes an input information acquisition unit acquiring model input information for CBRN pollution of indoor and outdoor spaces to be modeled, a pollution concentration data acquisition unit acquiring pollution concentration data for each time zone of the indoor and outdoor spaces, and a high-fidelity pollution diffusion prediction modeling unit correcting the pollution concentration data for each time zone of the indoor space by using artificial intelligence technology based on the model input information and the pollution concentration data, and calculating a pollution concentration for each lattice that partitions the indoor space.

Further, in the artificial intelligence-based threat prediction system for CBRN according to the present invention, the input information acquisition unit includes a spatial information acquisition unit acquiring information on the indoor and outdoor spaces to be modeled, and a user input unit inputting CBRN pollution source information and environmental setting information by a user.

Further, in the artificial intelligence-based threat prediction system for CBRN according to the present invention, the pollution concentration data acquisition unit acquires the time zone-wise pollution concentration data of the indoor and outdoor spaces, which is measured by using an actual detection sensor installed in a previously designated zone or by using a pollution diffusion prediction model which is based on the model input information.

Further, in the artificial intelligence-based threat prediction system for CBRN according to the present invention, the pollution concentration data acquisition unit includes a detection data acquisition unit acquiring the time zone-wise pollution concentration from the detection sensor installed in the indoor and outdoor spaces, and a pollution diffusion prediction modeling data acquisition unit acquiring time-wise pollution data of the space by using the pollution diffusion prediction model which predicts CBRN pollution diffusion formed based on the model input information.

Further, in the artificial intelligence-based threat prediction system for CBRN according to the present invention, the pollution diffusion prediction model conducts air current analysis by using multiple weather models with CBRN accident information and weather information as a condition, and calculates a prediction value for each time zone by using a pollution diffusion modeling technique with respect to a process in which a target pollutant is transferred and diffused in a calculation area.

Further, in the artificial intelligence-based threat prediction system for CBRN according to the present invention, the artificial intelligence technology is at least any one of a U-net, an LSTM network, a convolution LSTM network, and a GNN technique.

Further, in the artificial intelligence-based threat prediction system for CBRN according to the present invention, the high-fidelity pollution diffusion prediction modeling unit performs a function of simulatedly calculating a CBRN pollutant concentration change of a non-operation zone of the actual detection sensor or a zone in which pollution concentration calculated is restricted by the pollution diffusion prediction model in the indoor and outdoor spaces by using the U-Net technology.

Further, in the artificial intelligence-based threat prediction system for CBRN according to the present invention, the high-fidelity pollution diffusion prediction modeling unit includes a high-fidelity model generation unit regenerating high-fidelity pollution diffusion data in a designated zone by using the U-Net technology which is an artificial intelligence technique based on the model input information, a lattice generation unit generating a lattice that partitions the indoor and outdoor spaces based on user setting and the environmental setting information, and a high-fidelity pollution concentration calculating unit calculating the pollution concentration for each lattice in the designated zone based on the regenerated high-fidelity pollution diffusion data and the lattice.

Further, in order to achieve the object, the artificial intelligence-based threat prediction system for CBRN according to the present invention further includes: an operation control unit controlling an operation and a motion of the system, and generating output information for a pollution diffusion prediction result generated based on the calculated pollution concentration; and an output unit displaying the output information generated by the operation control unit.

In addition, in order to achieve the object, an artificial intelligence based CBRN threat prediction method according to the present invention includes: (a) acquiring, by an input information acquisition unit, model input information for a CBRN pollution in indoor and outdoor spaces to be modeled; (b) acquiring, by a pollution concentration data acquisition unit, time zone-wise pollution concentration data in the indoor and outdoor spaces; and (c) correcting, by a high-fidelity pollution diffusion prediction modeling unit, the time zone-wise pollution concentration data of the indoor space by using artificial intelligence technology based on the model input information and the pollution concentration data, and calculating a pollution concentration for each lattice that partitions the indoor space.

Further, in the artificial intelligence-based threat prediction method for CBRN according to the present invention, step (a) above includes (a1) acquiring, by a spatial information acquisition unit, information on the indoor and outdoor spaces to be modeled, and (a2) acquiring, by a user input unit, CBRN pollution source information and environmental setting information input by a user.

Further, in the artificial intelligence-based threat prediction method for CBRN according to the present invention, step (b) above includes acquiring, by the pollution concentration data acquisition unit, the time zone-wise pollution concentration data of the indoor and outdoor spaces, which is measured by using an actual detection sensor installed in a previously designated zone or by using a pollution diffusion prediction model which is based on the model input information.

Further, in the artificial intelligence-based threat prediction method for CBRN according to the present invention, step (b) above includes (b1) acquiring, by an actual detection sensor acquisition unit, a time-wise pollution concentration from the detection sensor installed in the indoor and outdoor spaces, and (b2) acquiring, by the pollution diffusion prediction modeling data acquisition unit, time-wise pollution data of the space by using the pollution diffusion prediction model which predicts CBRN pollution diffusion formed based on the model input information.

Further, in the artificial intelligence-based threat prediction method for CBRN according to the present invention, the pollution diffusion prediction model conducts air current analysis by using multiple weather models with CBRN accident information and weather information as a condition, and calculates a prediction value for each time zone by using a pollution diffusion modeling technique with respect to a process in which a target pollutant is transferred and diffused in a calculation area.

Further, in the artificial intelligence-based threat prediction method for CBRN according to the present invention, step (c) above includes simulatedly calculating a CBRN pollutant concentration change of a non-operation zone of the actual detection sensor or a zone in which pollution concentration calculated is restricted by the pollution diffusion prediction model in the indoor and outdoor spaces by using the U-Net technology.

Further, in the artificial intelligence-based threat prediction method for CBRN according to the present invention, step (c) above includes (c1) regenerating, by a high-fidelity model generation unit, high-fidelity pollution diffusion data in a designated zone by using the U-Net technology which is an artificial intelligence technique based on the model input information, (c2) generating, by a lattice generation unit, a lattice that partitions the indoor and outdoor spaces based on user setting and the environmental setting information, and (c3) calculating, by a high-fidelity pollution concentration calculating unit, the pollution concentration for each lattice in the designated zone based on the regenerated high-fidelity pollution diffusion data and the lattice.

In addition, in order to achieve the object, an artificial intelligence-based threat prediction system for CBRN executes the threat prediction method for CBRN.

Specific details of other exemplary embodiments are included in “Details for carrying out the invention” and accompanying “drawings”.

Advantages and/or features of the present invention, and a method for achieving the advantages and/or features will become obvious with reference to various exemplary embodiments to be described below in detail together with the accompanying drawings.

However, the present invention is not limited only to a configuration of each exemplary embodiment disclosed below, but may also be implemented in various different forms. The respective exemplary embodiments disclosed in this specification are provided only to complete disclosure of the present invention and to fully provide those skilled in the art to which the present invention pertains with the category of the invention, and the present invention will be defined only by the scope of each claim of the claims.

According to the present invention, in order to overcome an operation restriction of an actual detection sensor directly installed in a zone and a limitation of a CBRN pollution prediction analysis modeling technique utilized in a complex geography in the event of a CBRN situation, a system and a method for correcting and advancing CBRN pollution diffusion information for each time zone previously measured or predicted more realistically by introducing artificial intelligence technology.

Further, according to the present invention, a CBRN pollution diffusion prediction model can be continuously learned and prediction can be improved as time elapses by using AI technology such as U-Net, when new data is received, understanding pollution diffusion dynamics can be updated, and as a result, the prediction can be adjusted, and prediction accuracy can be kept or increased even though a situation and a condition are changed through a repeated improvement process.

Further, according to the present invention, the Al based CBRN pollution diffusion prediction model can have high adaptability and process a wide range of pollution scenario, and a prediction strategy can be adjusted according to input data according to a single or multiple contamination sources and a change of an environmental factor.

Further, according to the present invention, the CBRN pollution diffusion prediction information is reliably provided to provide information useful for a disk management and response plan.

That is, a system and a method for predicting a threat for CBRN can be provided, which can help to identify a region or an interior space which is likely to be affected by the CBRN pollution diffusion, make a decision on evacuation or home evacuation command, and guide resource arrangement for alleviating the influence of pollution.

### BRIEF DESCRIPTION OF THE DRAWINGS

FIG. 1 is a block diagram of an artificial intelligence based CBRN threat prediction system according to an exemplary embodiment of the present invention.

FIG. 2 is a flowchart of an artificial intelligence based CBRN threat prediction method according to an exemplary embodiment of the present invention.

FIG. 3 is a diagram illustrating a detailed flow the artificial intelligence based CBRN threat prediction method using the artificial intelligence based CBRN threat prediction system according to an exemplary embodiment of the present invention.

FIG. 4 is a conceptual view related to U-Net technology which is artificial intelligence technology used in a high-fidelity pollution diffusion prediction modeling unit applied to the artificial intelligence based CBRN threat prediction method according to an exemplary embodiment of the present invention.

### DETAILED DESCRIPTION OF THE INVENTION

Before describing the present invention in detail, the terms or words used in this specification should not be construed as being unconditionally limited to their ordinary or dictionary meanings, and in order for the inventor of the present invention to describe his/her invention in the best way, concepts of various terms may be appropriately defined and used, and furthermore, the terms or words should be construed as means and concepts which are consistent with a technical idea of the present invention.

That is, the terms used in this specification are only used to describe preferred embodiments of the present invention, and are not used for the purpose of specifically limiting the contents of the present invention, and it should be noted that the terms are defined by considering various possibilities of the present invention.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but further includes any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side”, “other side”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present invention may be described while being partially exaggerated, reduced, or omitted for sufficiently clearly delivering the spirit of the present invention, and thus the proportion or scale may not be exact.

Further, hereinafter, in describing the present invention, a detailed description of a configuration determined that may unnecessarily obscure the subject matter of the present invention, for example, a detailed description of a known technology including the prior art may be omitted.

Hereinafter, a preferable embodiment of the present invention will be described in detail with reference to the accompanying drawings.

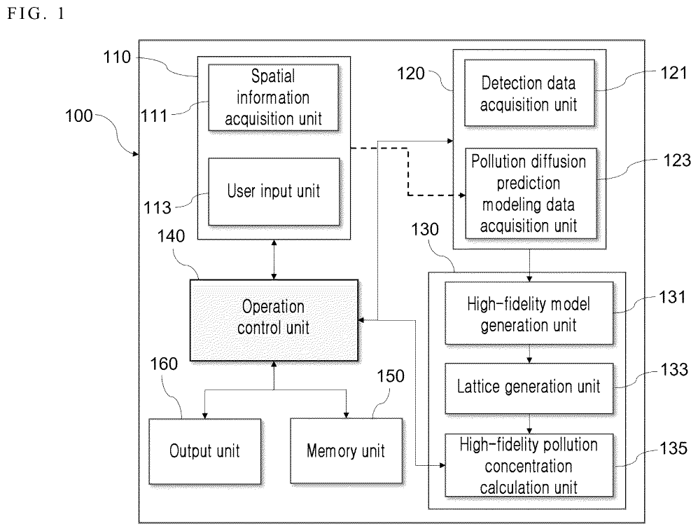

FIG. 1 is a block diagram of an artificial intelligence based CBRN threat prediction system 100 according to an exemplary embodiment of the present invention.

As illustrated in FIG. 1, the artificial intelligence based CBRN threat prediction system 100 according to an exemplary embodiment of the present invention may be configured to include an input information acquisition unit 110 acquiring model input information for CBRN pollution of indoor and outdoor spaces to be modeled, a pollution concentration data acquisition unit 120 acquiring pollution concentration data for each time zone of the indoor and outdoor spaces, and a high-fidelity pollution diffusion prediction modeling unit 130 correcting the pollution concentration data for each time zone of the indoor space by using artificial intelligence technology based on the model input information and the pollution concentration data, and calculating a pollution concentration for each lattice that partitions the indoor space.

As such, the artificial intelligence based CBRN threat prediction system 100 according to an exemplary embodiment of the present invention provides a system that learns pollution measurement or prediction information for each time in a background of various indoor and outdoor spaces defined by a user to effectively and intuitively calculate a pollution diffusion degree for an area of a sensor non-operation part or a part where pollution diffusion prediction is restricted within a designated zone.

As illustrated in FIG. 1, the input information acquisition unit 110 may be configured to include a user input unit 113 and a spatial information acquisition unit 111.

The spatial information acquisition unit 111 may be a component that acquires information on the indoor and outdoor spaces to be modeled, and the user input unit 113 may be a component in which CBRN pollution source information and environmental setting information are input by the user.

More specifically, the user input unit 113 as a component in which information on a vulnerable part in a space to be corrected or reconstructed and the environmental setting information are input may be a component in which the user inputs pollution source information which is not limited, but previous known, and environmental setting information including various conditions and settings for modeling.

The spatial information acquisition unit 111 as a component that acquires space information to be modeled, which intends to predict pollution diffusion may be a component that selects information on a space to be predicted in space information stored in a storage device such as a DB, etc., through a UI.

Here, among the space information, in particular, the indoor space information may be text file type RAW data including a CAD based building design result or predefined building design information, and the indoor and outdoor space information may be stored in an internal memory or the DB through a processing process in order to perform a CBRN diffusion modeling function.

In addition, as illustrated in FIG. 1, the pollution concentration data acquisition unit 120 may be a component that acquires the pollution concentration data for each time zone of the indoor and outdoor spaces, which is measured by using an actual detection sensor installed in a previously designated zone or by using a pollution diffusion prediction model which is based on model input information.

That is, the pollution concentration data acquisition unit 120 may be configured to include a detection data acquisition unit 121 and a pollution diffusion prediction modeling data acquisition unit 123.

The detection data acquisition unit 121 as a component that acquires the pollution concentration for each time zone from the detection sensor installed in the indoor and outdoor spaces may be a component that acquires detection data from various detection sensors (an environmental sensor, a gas sensor, a smoke sensor, etc.) installed in a previously designated zone in real time.

The pollution diffusion prediction modeling data acquisition unit 123 may be a component that acquires pollution data for each time of the space by using a pollution diffusion prediction model that predicts CBRN pollution diffusion formed based on the model input information.

Here, the pollution diffusion prediction model which conducts air current analysis by using multiple weather models with CBRN accident information and weather information as a condition, and calculates a prediction value for each time zone by using a pollution diffusion modeling technique with respect to a process in which a target pollutant is transferred and diffused in a calculation area may be a pollution diffusion prediction modeling tool such as HPAC and NBC_RAMS.

In addition, as illustrated in FIG. 1, the high-fidelity pollution diffusion prediction modeling unit 130 may be a component that corrects the pollution concentration data for each time zone of the indoor space by using the artificial intelligence technology based on the model input information and the pollution concentration data acquired through the pollution diffusion prediction modeling tool, and calculates the pollution concentration for each lattice that partitions the indoor space.

Further, the high-fidelity pollution diffusion prediction modeling unit 130 may perform a function of simulatedly calculating a CBRN pollutant concentration change of a non-operation zone of the actual detection sensor or a zone in which pollution concentration calculated is restricted by the pollution diffusion prediction model in the indoor and outdoor spaces by using the U-Net technology.

More specifically, as illustrated in FIG. 1, the high-fidelity pollution diffusion prediction modeling unit 130 may be configured to include a high-fidelity model generation unit that regenerates high-fidelity pollution diffusion data in the designated zone by using the U-Net technology which is the artificial intelligence technique based on the model input information, a lattice generation unit 133 that generates a lattice which partitions the indoor and outdoor spaces based on user setting and the environmental setting information, and a high-fidelity pollution concentration calculation unit 135 that calculates the pollution concentration for each lattice in the designated zone based on the regenerated high-fidelity pollution diffusion data and the lattice.

In addition, the artificial intelligence technology used by the high-fidelity pollution diffusion prediction model unit may be at least any one of a U-net, an LSTM network, a convolution LSTM network, and a GNN technique.

The U-Net technology is a fully-convolutional network primarily used for a purpose of reanalyzing a 2D image in a biomedical field. More specifically, a given 2D image is segmented for each pixel to classify respective pixels into a specific class.

This technology is a scheme that recalculates a restricted region concentration value by referring to pollution concentration data of a surrounding space of a restricted region (a metropolitan complex geography in which actual detection sensor measurement is restricted or it is difficult to calculate the concentration by the pollution diffusion prediction tool) through encoding and decoding processes by receiving the pollution concentration data for each pixel by using the U-Net which is the image segmentation technology.

The simple encoding and decoding processes may lose precise positional information for an image object, while the U-Net technology enables an accurate location to be determined by using a skip connection method that directly connects each encoding layer and each decoding layer.

Here, the high-fidelity model generation unit 131 applies a partial convolution scheme for more effective feature area extraction in the process of calculating the pollution concentration.

The partial convolution scheme which applies the calculation only to a valid pixel in the image is applied to a process of recalculating the concentration data of the restricted region by utilizing a high-reliability surrounding value.

Further, the high-fidelity pollution diffusion prediction model unit may use a long short-term memory (LSTM) network, a convolution long short-term memory (LSTM) network, a graph neural network (GNN), and an ensemble method.

The LSTM network technology which processes time series data, in particular, as a kind of effective recurrent neural network (RNN) technology may ‘store’ information for a long time, so the LSTM network technology is suitable for a task that predicts a future event based on past data.

The LSTM network may be trained to predict a future CBRN pollution level based on past CBRN pollution data jointly with other related elements such as the weather condition or human activities.

In addition, the convolution LSTM network as a network that combines a spatial pattern recognition ability of the CNN and a spatial pattern recognition ability of the LSTM network may analyze a spatial distribution and a change according to the time of the CBRN pollution.

Further, the convolution LSTM network may become an effective tool in predicting the diffusion of the pollution in both the space and the time.

The GNN is effective technology in analyzing data of a graph structure in which each node is connected to another node through an edge, and in a context of predicting the CBRN pollution diffusion, each location in a target space may become the node and a connection between locations may become the edge.

Therefore, the GNN may analyze the pollution diffusion in the entire graph, and predict the future pollution level at each node.

The ensemble method as technology that creates a final prediction by combining predictions of various models may often obtain a better performance than using only individual models. For example, in order to predict a future pollution concentration, ensembles of various models such as the U-Net, the LSTM, and the GNN may be used.

Besides, reinforced learning (RL) may be used, and this is more generally used in a decision making task, but when the task is constituted by a series of decision makings (e.g., predicting the pollution diffusion is the same as determining the pollution level of each location in each time stage of the future), the RL may be applied to the prediction of the pollution diffusion. The RL potentially integrates feedbacks of an environment to improve the prediction over time.

The artificial intelligence technology used by the high-fidelity pollution diffusion prediction modeling unit 130 has unique advantages and disadvantages, and may be appropriately selected and applied according to specific characteristics of the task and the data.

In addition, as illustrated in FIG. 1, the lattice generation unit 133 may be a component that partitions the indoor space to be modeled based on the user setting and the environmental setting information (user input information).

Here, the lattice generation unit 133 may be a component that generates the lattice by introducing an immersed boundary method (IBM) into the indoor space.

The high-fidelity pollution concentration calculation unit 135 may be a component that calculates the pollution concentration for each lattice in the designated zone of the indoor space based on the generated high-fidelity model and the lattice.

Meanwhile, in order to more accurately obtain a simulation result for a fluid flow, a lattice (grid/mesh or lattice) for calculation should also be considered in addition to a numerical analysis model.

A fluid is basically a continuum, but in order to compute the fluid in a computer, the fluid should be discretized to be processed by the computer.

That is, a lattice such as a Go board is created by finely cutting a large space, and each lattice point represents surrounding flow field data, so a normal numerical solution may be acquired only by densely putting the lattice into a part where a flow field is complicatedly changed when creating the lattice.

However, in that a too large computation amount is required if a lot of lattices are necessarily put, the lattice may be easily generated by using the immersed boundary method (IBM) by a technique of generating the lattice by the lattice generation unit 133 of the high-fidelity pollution diffusion prediction modeling unit 130 applied to an exemplary embodiment of the present invention.

The immersed boundary method as a method initially developed to simulate movement of a heart and a blood flow by Peskin in 1972 has a feature in which a given simulation is executed in a right-angle coordinate lattice and a peculiar process considering an effect of an immersed boundary on a flow is formed.

Since the lattice is very simply generated by using the immersed boundary method (IBM), there is an advantage in that it is relatively easy to develop a computing model of a CBRN fluid flow in the indoor space having a complicated geometric shape or movement boundary.

Further, in that a time and an effort required for preparing for and initializing the simulation may be remarkably reduced because the need for the complicated lattice is removed, the generation of the lattice using the IBM may be very suitable for a complicated turbulence flow of the CBRN fluid diffused in the indoor space, an interaction of the fluid and the structure, and a complex physical simulation.

Further, the pollution concentration calculation unit 135 may be a component that calculates the pollution concentration for each lattice based on a pollution concentration result calculated by the high-fidelity model generation unit 131 and the lattice generated in the zone.

In addition, the pollution concentration calculation unit 135 may be a component that calculates the pollution concentration for each lattice in the designated zone based on the regenerated high-fidelity model pollution diffusion data and the lattice.

That is, the pollution concentration for each lattice in the designated zone of the indoor space may be calculated based on the generated high-fidelity pollution diffusion data and the lattice by using a GPU parallel high-speed computation processing technique.

That is, the artificial intelligence based CBRN threat prediction system 100 according to an exemplary embodiment of the present invention may further include a GPU system for processing the pollution concentration for each lattice at a high speed by parallel computation.

In addition, as illustrated in FIG. 1, the artificial intelligence based CBRN threat prediction system 100 according to an exemplary embodiment of the present invention may be configured to further include an operation control unit 140 that controls an operation and a motion of the system, and generates output information for a pollution diffusion prediction result generated based on the calculated pollution concentration, and an output unit 160 that displays the output information generated by the operation control unit 140.

More specifically, as illustrated in FIG. 1, the artificial intelligence based CBRN threat prediction system 100 according to an exemplary embodiment of the present invention may be configured to include the operation control unit 140, an input information acquisition unit 110 constituted by a user input unit 113 and a spatial information acquisition unit 111 connected to the operation control unit 140, a pollution concentration data acquisition unit 120 constituted by a detection data acquisition unit 121 and a pollution diffusion prediction modeling data acquisition unit 123 collecting and acquiring actual detection sensor measurement data, a high-fidelity pollution diffusion prediction modeling unit 130, a memory unit 150, and the output unit 160.

Here, the spatial information acquisition unit 111 may acquire indoor and outdoor space information defined by the user, and this may be text file type RAW data including a CAD based building design result or predefined building design information or outdoor map and geometry information constituted by latitude and longitude information.

Further, the acquired spatial information may be stored in an internal DB or memory through a preprocessing process in order to perform a pollution diffusion prediction modeling function.

In addition, the detection data acquisition unit 121 may acquire data acquired by measuring a time-wise change or concentration (mg/m3) of the pollution concentration in the designated zone by the spatial information acquisition unit 111 as the actual detection sensor measurement data acquired by the user in the user input unit 113.

Further, the pollution diffusion prediction modeling data acquisition unit 123 may acquire data acquired by predicting the time-wise concentration (mg/m3) as a result calculated through the simulation for the zone acquired by the spatial information acquisition unit 111 by using the pollution diffusion prediction modeling tool.

In addition, the high-fidelity pollution diffusion prediction modeling unit 130 may include a function of a CBRN pollutant concentration change numerical simulation in the sensor non-operation region or the complex region where the pollution diffusion prediction is somewhat restricted by using the U-Net technology which is the artificial intelligence technique with respect to the user input information including the CBRN accident information input by the user in the user input unit 113, and the zone acquired by the spatial information acquisition nit 111 and the pollution diffusion information acquired by the pollution concentration data acquisition unit 120.

Meanwhile, the memory unit 150 may store various data and programs for the motion of the artificial intelligence based CBRN threat prediction system 100 according to an exemplary embodiment of the present invention.

Further, the memory unit 150 may store spatial information, a CBRN pollutant library, and various environmental setting information for predicting and correcting the CBRN pollution diffusion.

In addition, the user input unit 113 as a component for receiving pollutant information, time zone-wise detection sensor measurement and pollution diffusion prediction modeling data, external environment information (weather information), and analysis setting and predefinition information to predict the pollution diffusion from the user may be a user interface (UI) means including a mechanical input means and a touch type input means.

Meanwhile, pollution source information such as information, a type, and a physical property of a toxic substance to predict the pollution diffusion may be information stored in the memory unit 150. In this case, at least one toxic substance may be selected according to an input of the user through the user input unit 113 and various information related to the selected toxic substance may be selected.

In addition, the output unit 160 may output various data of the artificial intelligence based CBRN threat prediction system 100 according to an exemplary embodiment of the present invention according to the control of the operation control unit 140. As an example, the output unit 160 outputs the corrected pollution diffusion prediction result as an imaging image to be visually confirmed by the user.

To this end, the output unit 160 may include at least one display unit capable of displaying image information. Here, the display unit may be implemented as a Cathode Ray Tube (CRT), a Plasma Display Panel (PDP), a Liquid Crystal Display (LCD), a Light Emitting Diode (LED), an Organic Light Emitting Diode (OLED), etc., but is not limited thereto.

Meanwhile, the operation control unit 140 may control an overall motion of the artificial intelligence based CBRN threat prediction system 100 according to an exemplary embodiment of the present invention. For example, the operation control unit 140 may control a motion and a motion order of each connected component, and control each connected component based on the information input through the user input unit 113.

Further, the operation control unit 140 may be selected with and receive at least one in a CBRN pollutant list prestored for pollution diffusion prediction and correction through the input unit.

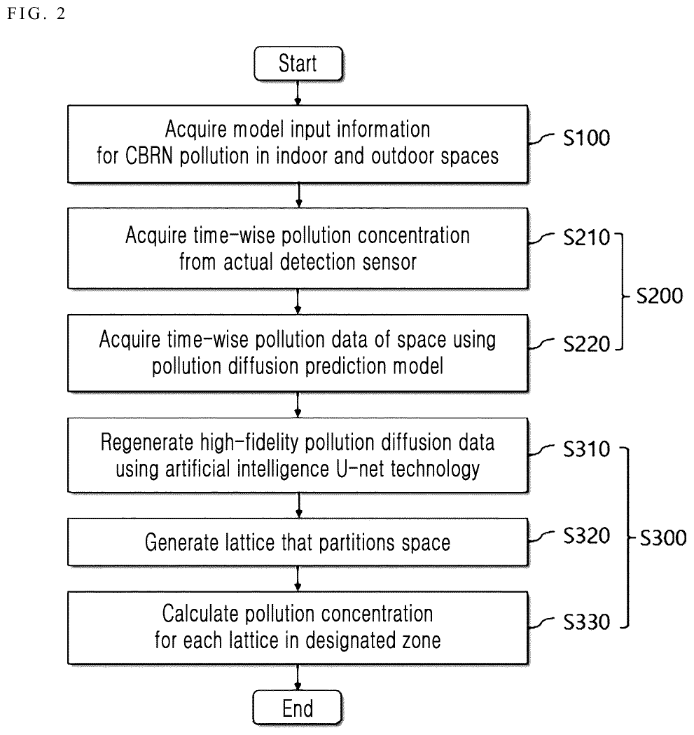

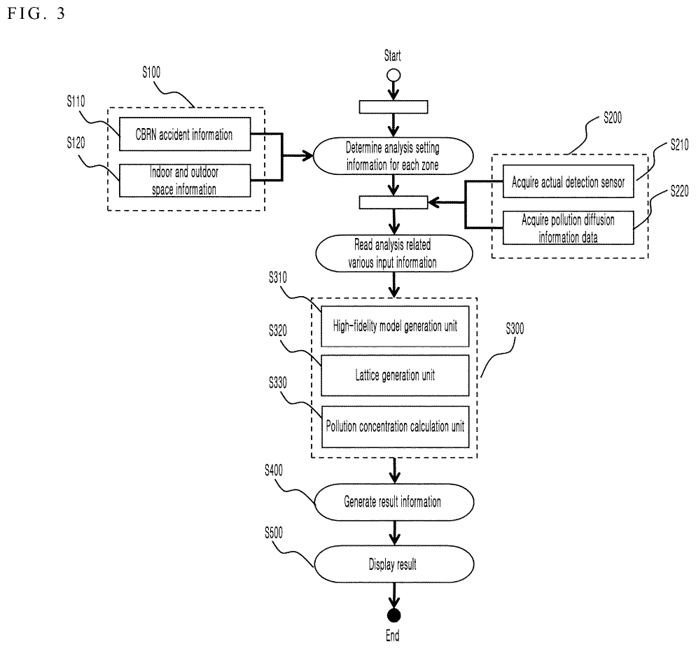

FIG. 2 is a flowchart of an artificial intelligence based CBRN threat prediction method according to an exemplary embodiment of the present invention and FIG. 3 is a diagram illustrating a detailed flow the artificial intelligence based CBRN threat prediction method using the artificial intelligence based CBRN threat prediction system 100 according to an exemplary embodiment of the present invention.

As illustrated in FIGS. 2 and 3, the artificial intelligence based CBRN threat prediction method according to an exemplary embodiment of the present invention may be configured to include (a) a step of acquiring, by an input information acquisition unit 110, model input information for CBRN pollution of indoor and outdoor spaces to be modeled (S100), (b) a step of acquiring, by a pollution concentration data acquisition unit 120, pollution concentration data for each time zone of the indoor and outdoor spaces (S200), and (c) a step of correcting, by a high-fidelity pollution diffusion prediction modeling unit 130, the pollution concentration data for each time zone of the indoor space by using artificial intelligence technology based on the model input information and the pollution concentration data, and calculating a pollution concentration for each lattice that partitions the indoor space (S300).

Here, (a) step S100 may include (a1) a step of acquiring, by a spatial information acquisition unit 111, spatial information of indoor and outdoor spaces to be modeled, and (a2) a step of acquiring, by a user input unit 113, CBRN pollution source information and environmental setting information input by a user.

Further, (b) step S200 may include a step of acquiring, by the pollution concentration data acquisition unit 120, the pollution concentration data for each time zone of the indoor and outdoor spaces, which is measured by using an actual detection sensor installed in a previously designated zone or by using a pollution diffusion prediction model which is based on model input information.

That is, step (b) may be a step of receiving time zone-wise pollution concentration data measured or predicted in an actual detection sensor non-operation region or in a state in which prediction using a pollution diffusion prediction tool is difficult or restricted.

Here, a data input scheme may include an offline scheme of reading a stored file and an online scheme of receiving pollution concentration data in connection with a network in real time.

More specifically, (b) step S200 may include (b1) step S210 of acquiring, by an actual detection sensor acquisition unit, a time-wise pollution concentration from a detection sensor installed in the indoor and outdoor spaces, and (b2) step S220 of acquiring, by a pollution diffusion prediction modeling data acquisition unit 123, the time-wise pollution data of the space by using the pollution diffusion prediction model which predicts CBRN pollution diffusion formed based on the model input information.

In addition, step (c) is a step of correcting the pollution concentration data for each time zone of the indoor space by using the artificial intelligence technology based on the model input information and the pollution concentration data acquired by the high-fidelity pollution diffusion prediction modeling unit 130, and calculating the pollution concentration for each lattice that partitions the indoor space.

That is, (c) step S300 may be a step of recalculating and correcting a pollution concentration for each lattice with respect to limited pollution concentration calculation data previously acquired by using a high-fidelity pollution diffusion prediction model.

More specifically, step (c) S300 may include (c1) a step of regenerating, by the high-fidelity model generation unit 131, the high-fidelity pollution diffusion data in the designated zone by using the U-Net technology which is the artificial intelligence technique based on the model input information (S310), (c2) a step of generating, by the lattice generation unit 133, the lattice that partitions the indoor and outdoor spaces based on the user setting and the environmental setting information (S320), and (c3) a step of calculating, by the high-fidelity pollution concentration calculation unit 135, the pollution concentration for each lattice in the designated zone based on the regenerated high-fidelity pollution diffusion data and the lattice (S330).

Here, step (c3) may be a step of calculating, by the high-fidelity pollution concentration calculation unit 135, the high-fidelity pollution diffusion data regenerated by using the artificial intelligence technology such as the U-net technology and the pollution concentration for each lattice in the designated through the high-fidelity pollution diffusion data by using a GPU parallel high-speed computation processing technique.

In addition, the artificial intelligence based CBRN threat prediction method according to an exemplary embodiment of the present invention may further include a step of generating, by the operation control unit 140, a pollution diffusion prediction result generated based on the pollution concentration calculated by the high-fidelity pollution diffusion modeling unit as output information including an image or video, and a step of displaying and outputting the generated output information.

Here, in the pollution diffusion prediction result image, pre-restricted actually measured or predicted pollution concentration result and high-fidelity prediction result zones may be display differently from each other, and the result image may be represented and displayed based on a concentration prediction value for each lattice size.

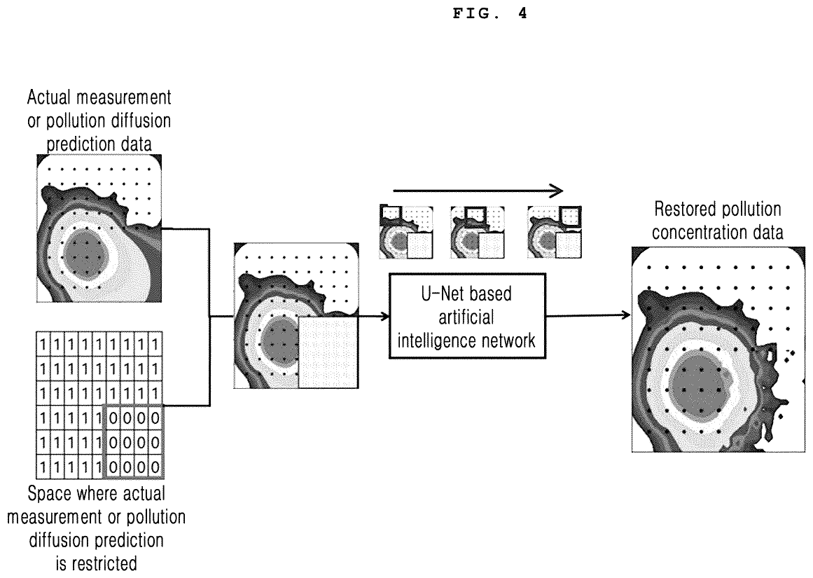

FIG. 4 is a conceptual view related to U-Net technology which is artificial intelligence technology used in a high-fidelity pollution diffusion prediction modeling unit 130 applied to the artificial intelligence based CBRN threat prediction method according to an exemplary embodiment of the present invention.

As illustrated in FIG. 4, the spatial information acquired by the model input information acquisition unit 110 receives, as input values, a pollution diffusion target region, and an actual detection sensor non-operation region designated by the user and a zone where pollution diffusion prediction is restricted.

Further, time zone-wise pollution concentration information data using the actual detection sensor or pollution diffusion prediction tool, which is measured in the designated zone is acquired.

By determining input information, U-Net based pollution diffusion correction artificial intelligence technology recalculates a pollution concentration value at an empty space (a region where measurement or prediction of the pollution concentration value is restricted) in sequence while sequentially moving partial spaces by using pre-designated mask information and a partial convolution technique.

Further, the U-Net based pollution diffusion correction artificial intelligence technology includes a function of reading various setting information acquired by the input information acquisition unit 110 and storing a calculation result in a memory, and the calculated result is stored as the image or a time zone-wise moving picture according to the user setting, and displayed on a screen through the output unit 160.

Further, as a display result, the pollution concentration actual measurement or prediction value used as previously input data and the pollution concentration result value corrected according to the U-Net based pollution diffusion prediction correction artificial intelligence technology may be displayed on the screen in an overlay format according to the user setting.

The present invention described above can be embodied as computer readable codes on a medium in which a program is recorded. The computer readable medium includes all kinds of recording devices storing data which may be deciphered by a computer system. Examples of the computer readable recording medium include a Hard Disk Drive (HDD), a Solid State Disk (SSD), a Silicon Disk Drive (SDD), a ROM, a RAM, a CD-ROM, a magnetic tape, a floppy disk, an optical data storage device, and the like and further include a device implemented as a type of a carrier wave (e.g., transmission through the Internet). Further, the computer may also include the operation control unit 140.

Meanwhile, the aforementioned contents can be corrected and modified by those skilled in the art without departing from the essential characteristics of the present invention. Accordingly, the aforementioned detailed description should not be construed as restrictive in all terms and should be exemplarily considered. The scope of the present invention should be determined by rational construing of the appended claims and all modifications within an equivalent scope of the present invention are included in the scope of the present invention.

In the above, although several preferred embodiments of the present invention have been described with some examples, the descriptions of various exemplary embodiments described in the “Specific Content for Carrying Out the Invention” item are merely exemplary, and it will be appreciated by those skilled in the art that the present invention can be variously modified and carried out or equivalent executions to the present invention can be performed from the above description.

In addition, since the present invention can be implemented in various other forms, the present invention is not limited by the above description, and the above description is for the purpose of completing the disclosure of the present invention, and the above description is just provided to completely inform those skilled in the art of the scope of the present invention, and it should be known that the present invention is only defined by each of the claims.

What is claimed is:

1. An artificial intelligence-based threat prediction system for Chemical, Biological, Radiological and Nuclear (CBRN) threats, comprising:
an input information acquisition unit acquiring model input information for a CBRN pollution of indoor and outdoor spaces to be modeled;
a pollution concentration data acquisition unit acquiring time zone-wise pollution concentration data of the indoor and outdoor spaces; and
a high-fidelity pollution diffusion prediction modeling unit correcting the time zone-wise pollution concentration data of the indoor space by using artificial intelligence technology based on the model input information and the pollution concentration data, and calculating a pollution concentration for each lattice that partitions the indoor space.

2. The artificial intelligence-based threat prediction system for CBRN threats of claim 1, wherein the input information acquisition unit includes
a spatial information acquisition unit acquiring information on the indoor and outdoor spaces to be modeled, and
a user input unit inputting CBRN pollution source information and environmental setting information by a user.

3. The artificial intelligence-based threat prediction system for CBRN threats of claim 1, wherein the pollution concentration data acquisition unit acquires the time zone-wise pollution concentration data of the indoor and outdoor spaces, which is measured by using an actual detection sensor installed in a previously designated zone or by using a pollution diffusion prediction model which is based on the model input information.

4. The artificial intelligence-based threat prediction system for CBRN threats of claim 1, wherein the pollution concentration data acquisition unit includes
a detection data acquisition unit acquiring the time zone-wise pollution concentration from the detection sensor installed in the indoor and outdoor spaces, and
a pollution diffusion prediction modeling data acquisition unit acquiring time-wise pollution data of the space by using the pollution diffusion prediction model which predicts CBRN pollution diffusion formed based on the model input information.

5. The artificial intelligence-based threat prediction system for CBRN threats of claim 4, wherein the pollution diffusion prediction model conducts air current analysis by using multiple weather models with CBRN accident information and weather information as a condition, and calculates a prediction value for each time zone by using a pollution diffusion modeling technique with respect to a process in which a target pollutant is transferred and diffused in a calculation area.

6. The artificial intelligence-based threat prediction system for CBRN threats of claim 1, wherein the artificial intelligence technology is at least any one of a U-net, an LSTM network, a convolution LSTM network, and a GNN technique.

7. The artificial intelligence-based threat prediction system for CBRN threats of claim 1, wherein the high-fidelity pollution diffusion prediction modeling unit performs a function of simulatedly calculating a CBRN pollutant concentration change of a non-operation zone of the actual detection sensor or a zone in which pollution concentration calculated is restricted by the pollution diffusion prediction model in the indoor and outdoor spaces by using the U-Net technology.

8. The artificial intelligence-based threat prediction system for CBRN threats of claim 1, wherein the high-fidelity pollution diffusion prediction modeling unit includes
a high-fidelity model generation unit regenerating high-fidelity pollution diffusion data in a designated zone by using the U-Net technology which is an artificial intelligence technique based on the model input information,
a lattice generation unit generating a lattice that partitions the indoor and outdoor spaces based on user setting and the environmental setting information, and
a high-fidelity pollution concentration calculating unit calculating the pollution concentration for each lattice in the designated zone based on the regenerated high-fidelity pollution diffusion data and the lattice.

9. The artificial intelligence-based threat prediction system for CBRN threats of claim 1, further comprising:
an operation control unit controlling an operation and a motion of the system, and generating output information for a pollution diffusion prediction result generated based on the calculated pollution concentration; and
an output unit displaying the output information generated by the operation control unit.

10. An artificial intelligence-based threat prediction system for Chemical, Biological, Radiological and Nuclear (CBRN) threats, comprising:
(a) acquiring, by an input information acquisition unit, model input information for a CBRN pollution in indoor and outdoor spaces to be modeled;
(b) acquiring, by a pollution concentration data acquisition unit, time zone-wise pollution concentration data in the indoor and outdoor spaces; and
(c) correcting, by a high-fidelity pollution diffusion prediction modeling unit, the time zone-wise pollution concentration data of the indoor space by using artificial intelligence technology based on the model input information and the pollution concentration data, and calculating a pollution concentration for each lattice that partitions the indoor space.

11. The artificial intelligence-based threat prediction method for CBRN threats of claim 10, wherein step (a) above includes
(a1) acquiring, by a spatial information acquisition unit, information on the indoor and outdoor spaces to be modeled, and
(a2) acquiring, by a user input unit, CBRN pollution source information and environmental setting information input by a user.

12. The artificial intelligence-based threat prediction method for CBRN threats of claim 10, wherein step (b) above includes
acquiring, by the pollution concentration data acquisition unit, the time zone-wise pollution concentration data of the indoor and outdoor spaces, which is measured by using an actual detection sensor installed in a previously designated zone or by using a pollution diffusion prediction model which is based on the model input information.

13. The artificial intelligence-based threat prediction method for CBRN threats of claim 10, wherein step (b) above includes
(b1) acquiring, by an actual detection sensor acquisition unit, a time-wise pollution concentration from the detection sensor installed in the indoor and outdoor spaces, and
(b2) acquiring, by the pollution diffusion prediction modeling data acquisition unit, time-wise pollution data of the space by using the pollution diffusion prediction model which predicts CBRN pollution diffusion formed based on the model input information.

14. The artificial intelligence-based threat prediction method for CBRN threats of claim 10, wherein the pollution diffusion prediction model conducts air current analysis by using multiple weather models with CBRN accident information and weather information as a condition, and calculates a prediction value for each time zone by using a pollution diffusion modeling technique with respect to a process in which a target pollutant is transferred and diffused in a calculation area.

15. The artificial intelligence-based threat prediction method for CBRN threats of claim 10, wherein step (c) above includes simulatedly calculating a CBRN pollutant concentration change of a non-operation zone of the actual detection sensor or a zone in which pollution concentration calculated is restricted by the pollution diffusion prediction model in the indoor and outdoor spaces by using the U-Net technology.

16. The artificial intelligence-based threat prediction method for CBRN threats of claim 10, wherein step (c) above includes
(c1) regenerating, by a high-fidelity model generation unit, high-fidelity pollution diffusion data in a designated zone by using the U-Net technology which is an artificial intelligence technique based on the model input information,
(c2) generating, by a lattice generation unit, a lattice that partitions the indoor and outdoor spaces based on user setting and the environmental setting information, and
(c3) calculating, by a high-fidelity pollution concentration calculating unit, the pollution concentration for each lattice in the designated zone based on the regenerated high-fidelity pollution diffusion data and the lattice.

17. An artificial intelligence-based threat prediction system for CBRN threats, wherein the threat prediction method for CBRN threats of claim 10 is executed.
